(19) United States
(12) Patent Application Publication
(10) Pub. No.: US 2008/0220665 A1
(43) Pub. Date: Sep. 11, 2008

(54) Compliant pin components for a printed circuit board assembly

(76) Inventors: Christopher J. Darr, Livonia, MI (US); Peter P. Kowtun, Plymouth, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/715,681

(22) Filed: Mar. 8, 2007

(51) Int. Cl. H01R 13/11

(52) U.S. Cl. 439/842

(57) ABSTRACT

A self-contained power distribution device is provided having compliant pins for attachment to mating receptacles of a printed circuit board for use in a vehicle electrical system. An insulative body forms a housing. An electrical switching element is disposed within the housing. A plurality of non-coaxial terminal contacts extend from a lower planar surface of the housing. Each of the plurality of terminal contacts is substantially parallel to one another having exposed portions adapted to be received by the mating receptacles of a printed circuit board. The plurality of terminal contacts is in electrical communication with the switching element. The exposed portion of the plurality of terminal contacts each has a compliance feature that is resilient to deformation when received by the mating receptacles of the printed circuit board. An interference condition occurs between the compliance feature and the mating receptacles.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of Invention

This invention relates in general to compliant pins, and more specifically, to utilizing compliant pins in relays.

2. Background of Related Art

The electronics manufacturing industry is facing a change in its assembly processes. Soldering has been used world wide in the electronic industry for electrically coupling electronic devices to one another such as wiring and terminals to circuit boards (PCBs). Lead based solder has been used almost exclusively in the electronics industry for attaching components of various electronic devices to PCBs. Solders have been primarily used because they are inexpensive and are primarily reliable under various operating conditions. Soldering also possesses highly favorable characteristics such as high strength ductility, high thermal cycling, high strength durability and joint integrity.

However, concerns have been increasingly growing due to the contamination of heavy metals such as lead ending up in landfills. As a result, there has been a worldwide movement to utilize environmentally friendly soldering methods and ban the use of heavy metals such as lead in solders.

Lead-free soldering materials have been tested and utilized with some success. However, issues remain with high temperature compatibility. Lead-free materials require a high temperature for reflow. The high temperature required for reflow may cause damage to the components being soldered together. This includes the plastic encapsulated devices such as capacitors, LEDs, connectors and electromechanical components, in addition to delaminating circuit boards. Therefore, there is a need for providing a reliable and durable electrical connection between two devices such as a relay and a printed circuit board without utilizing a soldering operation.

### BRIEF SUMMARY OF THE INVENTION

The present invention provides an advantage of eliminating soldering for the electrical coupling of a relay to a printed circuit board by using a press fit connection between a relay and a printed circuit board. The relay includes terminals having a compliance feature which assist is securing the relay to a printed circuit board or like device.

In one aspect of the present invention, a self-contained power distribution device is provided having compliant pins for attachment to mating receptacles of a printed circuit board for use in a vehicle electrical system. An insulative body forms a housing. An electrical switching element is disposed within the housing. A plurality of non-coaxial terminal contacts extends from a lower planar surface of the housing. The lower planer surface is substantially perpendicular to the plurality of terminal contacts. Each of the plurality of terminal contacts is substantially parallel to one another having exposed portions adapted to be received by the mating receptacles of a printed circuit board. The plurality of terminal contacts is in electrical communication with the switching element. The exposed portion of the plurality of terminal contacts each has a compliance feature. The compliance feature is resilient to deformation when received by the mating receptacles of the printed circuit board. An interference condition occurs between the compliance feature of the plurality of terminal contacts and the mating receptacles of the printed circuit board.

In yet another aspect of the present invention, a printed circuit board assembly is provided for use in a vehicle electrical system. The printed circuit board assembly includes a printed circuit board having mating receptacles extending through the printed circuit board. A self-contained power distribution device is releasably attachable to the mating receptacles of a printed circuit board. The self-contained power distribution device includes a housing and an electrical switching element disposed within the housing. The self-contained power distribution device further includes a plurality of non-coaxial terminal contacts extending from a lower planar surface of the housing. The lower planar surface being substantially perpendicular to the plurality of terminal contacts. Each of the plurality of terminal contacts is substantially parallel to one another and includes exposed portions adapted to be received by the mating receptacles of a printed circuit board. The plurality of terminal contacts are in electrical communication with the switching element. The exposed portion of the plurality of terminal contacts each includes a compliance feature. The compliance feature being resilient to deformation when received by the mating receptacles of the printed circuit board for creating an interference condition between the compliance feature and the mating receptacles of the printed circuit board.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a side view of a prior art coupling between a self-contained power distribution device and a printed circuit board.

FIG. 2 is a perspective view of a self-contained power distribution device aligned with the printed circuit board according to a first preferred embodiment of the present invention.

FIG. 3 is a cross section view of the self-contained power distribution device coupled to the printed circuit board according to the first preferred embodiment of the present invention.

FIG. 4 is a perspective view of a self-contained power distribution device according to a second preferred embodiment of the present invention.

FIG. 5 is a perspective view of a self-contained power distribution device according to a third preferred embodiment of the present invention.

FIG. 6 is a perspective view of a self-contained power distribution device according to a fourth preferred embodiment of the present invention.

FIG. 7 is a perspective view of a self-contained power distribution device according to a fifth preferred embodiment of the present invention.

### DETAILED DESCRIPTION OF THE PREFERRED EMBODIMENT

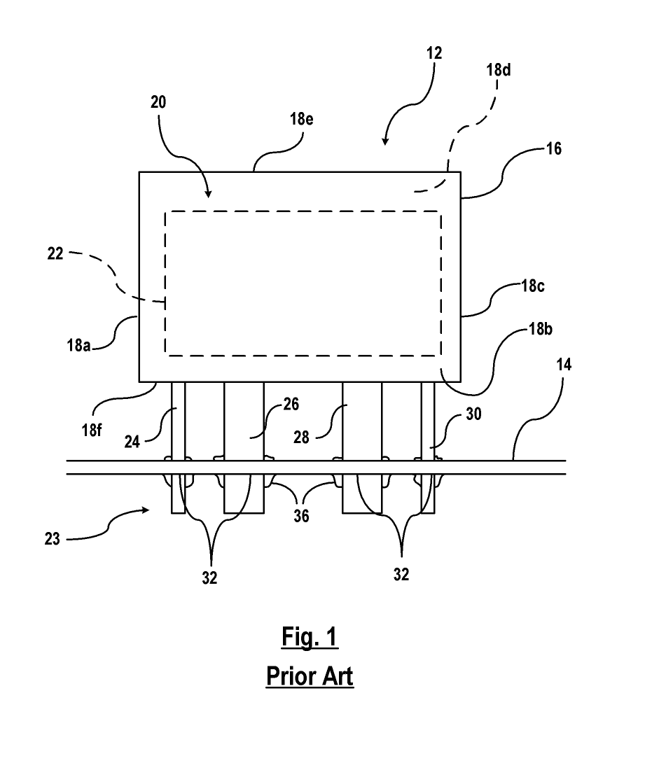

There is shown in FIG. 1 a self-contained power distribution device, such as a relay 12, electrically coupled to a printed circuit board (PCB) 14 as is known in the art. It is understood that the self-contained power distribution device is directed to components, such as relays, fuses, mini-fuses, or diodes mounted to the PCB, but does not include a PCB mounted to the PCB. The relay 12 includes a housing 16 formed from a non-conductive material such as plastic. The housing 16 includes a plurality of planar members 18 formed perpendicular to one another for forming an enclosed interior region 20. The plurality of planar members 18 include side surfaces 18a-d, an upper surface 18e, and a lower surface 18f.

A switching element 22 is disposed within the interior region 20. The switching element 22 includes contacts (not shown) that are moveable between an open position (i.e., open circuit) and a closed position (i.e., closed circuit). The switching element 22 also includes an electromagnetic coil (not shown) for generating an electromagnetic field for switching the contacts between the open and closed position. Alternatively, the switching element 22 may include other electrical elements for making and breaking the electrical circuit.

The switching element 22 is electrically coupled to a plurality of terminal contacts 23 extending through the housing for electrically providing an electrical connection with the PCB 14 disposed exterior of the housing 16. The plurality of terminals contacts 23 typically include a first terminal contact 24 and a second terminal contact 26 which are electrically coupled to the open and closeable contacts of the switching element 22. The third terminal contact 28 and fourth terminal contact 30 provide power to the electromagnetic element (not shown) for generating the electromagnetic field that opens and closes the contacts.

Each of the plurality of terminal contacts 23 protrude through respective through-holes, shown generally at 32, formed in the PCB 14 for making an electrical connection to traces of the PCB 14. The mechanical connection, as well as the electrical connection, is provided by a soldering operation. Solder 36 is applied at the through-holes 32 for forming an electrical and mechanical bond between the plurality of terminal contacts 23 and the PCB 14. The solder 36 not only forms an electrical connection to the PCB 14, but provides structural support for the relay 12 via the plurality of terminal contacts 23. The soldering operation is typically performed by heating the solder 36 to an elevated temperature for reflowing the solder to form a continuous bond between the PCB 14 and the terminal contacts 23. The solder 36 cools to a hardened state for forming the mechanical and electrical connection between the PCB 14 and the plurality of terminal contacts 23.

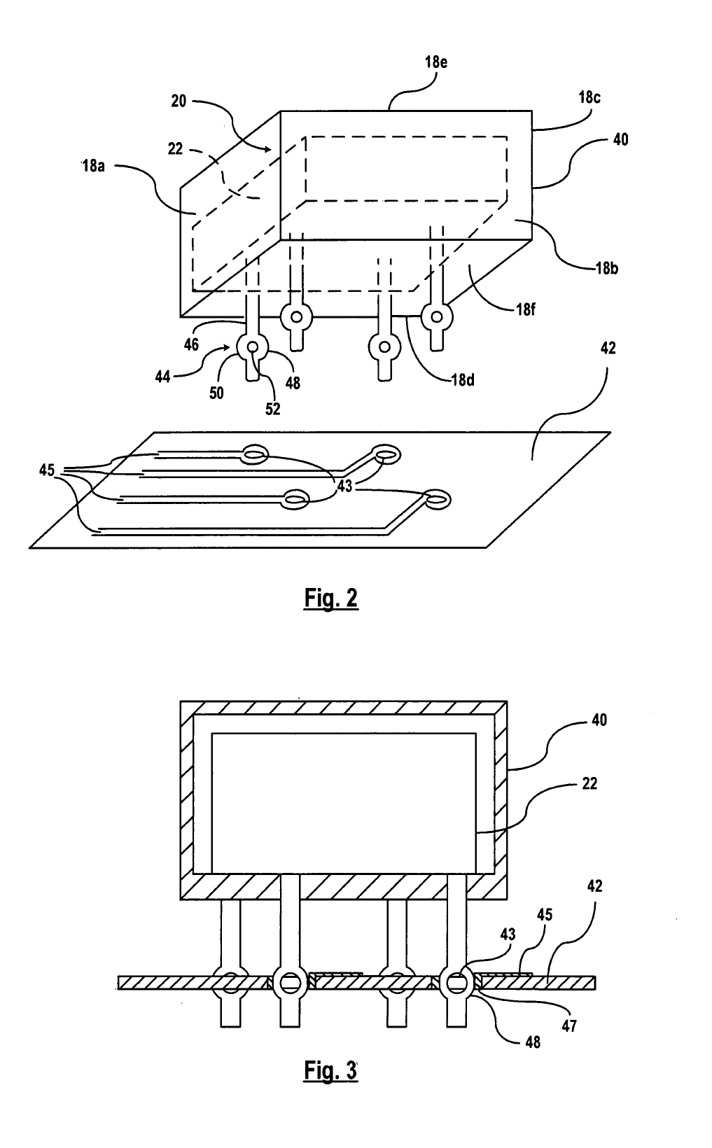

FIG. 2 illustrates a perspective view of a relay 40, according to the invention, aligned with a PCB 42. The PCB 42 may include a rigid-type PCB or flexible-type PCB. The PCB 42 includes a plurality of mating receptacles, generally referred to as through-holes 43 that are in electrical communication with a plurality of electrical traces 45 formed on the PCB 42.

The relay 40 includes the plurality of planar members 18a-f formed perpendicular to one another thereby enclosing the switching element 22 within the interior region 20. A plurality of terminal contacts 44 extends from the lower surface 18f of the relay 40 and is in electrical contact with the switching element 22.

The plurality of terminal contacts 44 includes an exposed portion having substantially straight edges 46 with a compliance feature 48 formed on a contacting region of each respective terminal contact. The compliance feature 48 includes an enlarged section 50, such as a bowed section, having an aperture 52 formed substantially concentric to the enlarged section 50. Preferably, the enlarged section 50 is substantially circular-shaped that extend beyond a width of the straight edges 46 of a respective terminal contact for creating an interference condition with the mating through-hole 43 of the PCB 14. The through-holes 43 are typically plated with a conductive material 47 that provides an electrical connection between the plurality of traces 45 and the associated enlarged sections 50 of the plurality of terminal contacts 23 when the relay 40 is secured to the PCB 42. As the compliance feature 48 is inserted within the through-hole 43, the conductive material 47 lining the interior of the through-hole 43 contacts the enlarged section 50 for making an electrical connection with the respective terminal contact. In addition, the plated through-hole 43, being smaller in diameter than the enlarged section 50 of the respective terminal, exerts a resistant force against the enlarged section 50 as the enlarged section 50 is inserted through the through-hole 43. The aperture 52 formed in the enlarged section 50 allows the enlarged section 50 to deform radially inward so that the enlarged section 50 may be press-fit within the through-hole 43. The compliance feature 48 is resilient to deformation when received by the through-hole 43 so that an interference condition may be created for seating the plurality of terminals contacts 44 within the respective through-holes 43 of the PCB 42 for providing a mechanical supporting connection and an electrical connection. The interference condition between the relay 42 and the PCB 42 eliminates any requirement for soldering or a socket. In addition, the compliance feature 48 allows the relay 40 to be releasably attachable (i.e., serviceable) to the PCB 42.

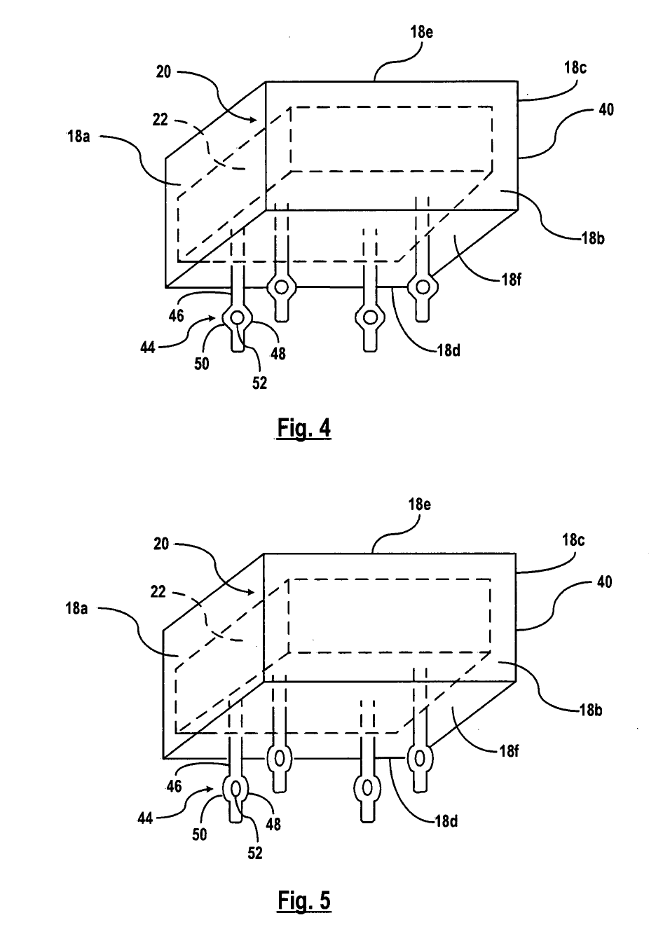

The enlarged section 50 may include other shapes including, but not limited to, diamond-shapes and oval-shapes, as shown in FIGS. 4 and 5 of the third and fourth embodiments, respectively, for creating an interference condition between the enlarged sections of the plurality of terminal contacts 44 and the through-holes 43 of the PCB 42.

FIG. 3 illustrates a cross section view of the interconnection of the relay 40 and the PCB 42. The relay 40 is secured to the PCB 42 by the interference condition between the enlarged section 50 of each respective terminal contact and the mating through-hole. The enlarged section 50 deforms radially inward as the enlarged section 50 is press-fit into the through-hole 43. The enlarged section 50 is resilient such that a restorative force is exerted against the interior surfaces of the through-hole 48 for creating the interference condition between the respective terminal contacts and the respective through-holes for securing the relay 40 to the PCB 42.

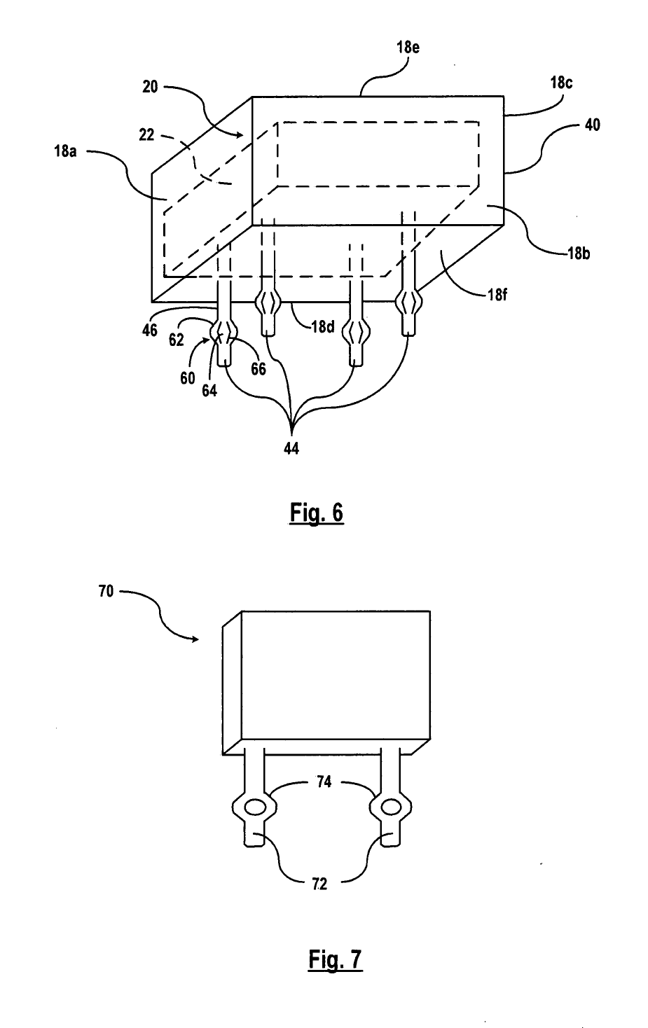

FIG. 6 illustrates a perspective view of a compliant pin relay according to a fourth preferred embodiment. The plurality of terminal contacts 44 includes a compliance feature 60 formed on a contacting region of each respective terminal contact. The compliance feature 60 includes an enlarged section 62 having at spring-like members 64 with compression slots 66 formed between the spring-like members 64. The compression slots 66 allow the spring-like members 64 to compress radially inward as the enlarged section 62 extends into the through-hole 43 of the PCB 42. The spring-like members 64 are resilient such that a restorative force is exerted against the inner wall of the through-hole 43 for maintaining the interference condition. The interference condition secures the enlarged section 62 of the respective terminal contact within the through-hole 43 of the PCB 12.

FIG. 7 illustrates a perspective view of a self-contained power distribution device according to a fifth preferred embodiment. The device 70 includes a pair of terminal contacts 72 having a compliance feature 74 formed on a contacting region of each respective terminal contact. The device 70 may include a fuse, mini-fuse, diode, or similar device for attachment to a respective PCB. The compliance feature 74 maintains an interference condition with an inner wall of a respective through-hole of a PCB. It is understood that the compliance feature 74 allows the device 70 to be releasably attachable to the PCB.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope. For example, the enlarged section may include a resilient section (e.g., thin-wall section) that does not utilize an aperture or slot but is capable of compressing and expanding to maintain the interference condition between the terminal contact and the printed circuit board.

1. A self-contained power distribution device having compliant pins for attachment to mating receptacles of a printed circuit board for use in a vehicle electrical system comprising:
a housing;
an electrical switching element consisting of either a relay, a fuse, or a diode disposed within the housing; and
a plurality of terminal contacts connected to the electrical switching element and extending from the housing, the plurality of terminal contacts having respective exposed portions that are adapted to be received by mating receptacles of the printed circuit board, each of the exposed portions of the plurality of terminal contacts having a compliance feature that is resilient to deformation when received by the mating receptacles of the printed circuit board for creating an interference condition between the compliance feature of the terminal contacts and the mating receptacles of the printed circuit board.

2. The self-contained power distribution device of claim 1 wherein the compliant feature of the self-contained power distribution device attaches to a printed circuit board for an automotive electrical actuator to be used in vehicle.

3. The self-contained power distribution device of claim 1 wherein the compliance feature of the self-contained power distribution device attaches to a flexible printed circuit board.

4. The self-contained power distribution device of claim 1 wherein only a portion of the exposed electrical contacts mate with the receptacles of the printed circuit board.

5. The self-contained power distribution device of claim 1 wherein the compliance feature of each terminal contact includes an enlarged section.

6. The self-contained power distribution device of claim 5 wherein the enlarged section is bowed.

7. The self-contained power distribution device of claim 5 wherein the enlarged section includes an aperture therethrough.

8. The self-contained power distribution device of claim 5 wherein the enlarged section is substantially circular-shaped.

9. The self-contained power distribution device of claim 5 wherein the enlarged section is substantially oval-shaped.

10. The self-contained power distribution device of claim 5 wherein the enlarged section is substantially diamond-shaped.

11. The self-contained power distribution device of claim 5 wherein the enlarged section includes spring-like members separated by compression slots for allowing the resilient deformation of the spring-like members.

12. (canceled)

13. (canceled)

14. The self-contained power distribution device of claim 1 wherein the wherein the fuse includes a mini-fuse.

15. (canceled)

16. A printed circuit board assembly for use in a vehicle electrical system comprising:
a printed circuit board having mating receptacles extending through the printed circuit board; and
a self-contained power distribution device releasably attachable to the mating receptacles of a printed circuit board, the self-contained power distribution device including a housing and an electrical switching element disposed within the housing, the switching element consisting of either a relay, a fuse, or a diode, the self-contained power distribution device further including a plurality of non-coaxial terminal contacts extending from a lower planar surface of the housing, the lower planar surface being substantially perpendicular to the plurality of terminal contacts, each of the plurality of terminal contacts being substantially parallel to one another and having exposed portions adapted to be received by the mating receptacles of a printed circuit board, the plurality of terminal contacts are in electrical communication with the switching element, the exposed portion of the plurality of terminal contacts each having a compliance feature, the compliance feature being resilient to deformation when received by the mating receptacles printed circuit board for creating an interference condition between the compliance feature and the mating receptacles of the printed circuit board.

17. (canceled)

18. (canceled)

19. The printed circuit board assembly of claim 16 wherein the fuse includes a mini-fuse.

20. (canceled)
